(19) United States
(12) Patent Application Publication
(10) Pub. No.: US 2024/0296343 A1
(43) Pub. Date: Sep. 5, 2024

(54) DATA FUSION METHOD AND APPARATUS FOR DISTRIBUTED GRAPH LEARNING

(71) Applicant: Alipay (Hangzhou) Information Technology Co., Ltd., Hangzhou (CN)

(72) Inventor: Zhiqiang GUO, Hangzhou (CN)

(21) Appl. No.: 18/572,995

(22) PCT Filed: Oct. 14, 2022
(86) PCT No.: PCT/CN2022/125423

§ 371 Date: Dec. 21, 2023

(30) Foreign Application Priority Data
Nov. 25, 2021 (CN) 202111413646.9

(51) Int. Cl. G06N 3/098

(52) U.S. Cl. CPC G06N 3/098

(57) ABSTRACT

Embodiments of this specification provide a data fusion method for distributed graph learning, applied to a distributed graph learning process for graph data in a distributed system. A single device in the distributed system is pre-allocated with a plurality of graph nodes of the graph data and a corresponding node connection relationship, a first device includes N graph nodes and M mirror nodes, a single mirror node and a single graph node in the N graph nodes are neighboring nodes of each other, and in a data fusion process for distributed graph learning, the first device performs a fusion operation on each of the M mirror nodes through a plurality of mutually independent mirror fusion threads, and separately adds a mirror fusion vector of a mirror node to a local aggregation data sequence. In addition, the first device sequentially sends, through a sending thread, mirror fusion vectors.

This application claims priority to Chinese Patent Application No. 202111413646.9, filed with the China National Intellectual Property Administration on Nov. 25, 2021, and entitled “DATA FUSION METHOD AND APPARATUS FOR DISTRIBUTED GRAPH LEARNING”, which is incorporated herein by reference in its entirety.

### TECHNICAL FIELD

One or more embodiments of this specification relate to the field of computer technologies, and in particular, to a data fusion method and apparatus for distributed graph learning.

### BACKGROUND

Graph data is a data form that describes an association relationship between various entities. The graph data can usually include a plurality of nodes, and all nodes respectively correspond to all service entities. When the service entity has a predefined association attribute, a corresponding node of the graph data can have a corresponding association relationship based on the association attribute. For example, in graph data represented by several triplets, a triplet (a, r, b) indicates that there is an association relationship r between a node a and a node b. In visualized graph data, the node a and the node b are represented by points, and the corresponding association relationship r between the node a and the node b can be represented by a connection edge. The graph data can be usually processed by using a graph model. In other words, graph learning is performed.

In a graph learning process, the graph data can be processed by using the graph model. During graph learning, neighboring node information of each node in the graph data can be fused into information about the node, to consider mutual impact of nodes. With development of a graph learning technology, graph learning is applied more widely. In some service scenarios, the graph data has a large scale, for example, can include a quantity of nodes at a level of one billion or 10 billion. For a large node scale, distributed graph learning can be used. That is, the graph data is segmented and stored on a plurality of devices. However, there can be an association relationship between nodes distributed on different devices. In a process of fusing neighboring node information of each node in the graph data into information about the node, devices need to interact with each other.

### SUMMARY

One or more embodiments of this specification describe a data fusion method and apparatus for distributed graph learning, to resolve one or more problems mentioned in the background.

According to a first aspect, a data fusion method for distributed graph learning is provided, and is applied to a distributed graph learning process for graph data in a distributed system. A single device in the distributed system is pre-allocated with a plurality of graph nodes of the graph data and a corresponding node connection relationship, a first device includes N graph nodes and M mirror nodes, a single mirror node is a mirror of a corresponding graph node on another device, the single graph node corresponding to the single mirror node on the another device and a single graph node in the N graph nodes are neighboring nodes of each other, and in a data fusion process for distributed graph learning, the method is performed by the first device, and includes: performing the following fusion operations on each of the M mirror nodes through a plurality of mutually independent mirror fusion threads: obtaining a current representation vector of the single mirror node, where the current representation vector of the single mirror node is provided by a device in which the corresponding graph node is located; determining a mirror fusion vector of the single mirror node based on a current representation vector of the graph node and a current representation vector of each neighboring node of the graph node on the first device, where a representation vector of a single node is used to describe attribute information of a corresponding graph node; and adding the mirror fusion vector to a local aggregation data sequence; and sequentially sending, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.

In an embodiment, the graph learning is performed by processing the graph data by using a graph model with a multi-layer iterative structure, the fusion operation is correspondingly performed at a single layer of the graph model, and when the single layer is the first layer, a current representation vector of the single graph node is a feature vector extracted based on attribute information of an entity corresponding to the single graph node, or when the single layer is not the first layer, a current representation vector of the single graph node is a representation vector corresponding to attribute information that is of the single graph node and that is fused at a previous layer.

In an embodiment, the graph node is recorded in a candidate node queue when the device in which the graph node corresponding to the single mirror node is located provides the current representation vector of the graph node, the candidate node queue is used to store a current representation vector of a local mirror node or a local graph node, and all the fusion threads sequentially obtain a single current representation vector at a single time.

In an embodiment, the mirror fusion vector of the single mirror node is determined by obtaining one of a sum, an average, a weighted sum, and a median of current representation vectors of neighboring nodes of the graph node in the N graph nodes.

In an embodiment, the N graph nodes include a first node, the first node corresponds to mirror nodes distributed on S devices and R local neighboring nodes, R is greater than or equal to 0, and for the first node, the method further includes: fusing a current representation vector of the R neighboring nodes and a current representation vector of the first node through a single local fusion thread in a plurality of local fusion threads, to obtain a local fusion vector of the first node; and fusing, through a single aggregation thread in a plurality of aggregation threads, the local fusion vector and S mirror fusion vectors respectively determined by the S devices for the first node, to obtain attribute information fused for the first node, so as to update the current representation vector of the first node.

In an embodiment, the fusing, through a single aggregation thread in a plurality of aggregation threads, the local fusion vector and S mirror fusion vectors respectively determined by the S devices for the first node includes: obtaining the S mirror fusion vectors respectively determined by the S devices for the first node; and fusing the S mirror fusion vectors and the local fusion vector of the first node.

In an embodiment, the fusing, through a single aggregation thread in a plurality of aggregation threads, the local fusion vector and S mirror fusion vectors respectively determined by the S devices for the first node includes: obtaining a single mirror fusion vector that is of the first node and that is received from a single device in the S devices; aggregating the single mirror fusion vector to a mirror aggregation vector of the first node until the S mirror fusion vectors sent by the S devices are all aggregated, to obtain a mirror aggregation result; and fusing the mirror aggregation result and the local fusion vector of the first node.

In an embodiment, the fusing, through a single aggregation thread in a plurality of aggregation threads, the local fusion vector and S mirror fusion vectors respectively determined by the S devices for the first node includes: in response to receiving a single mirror fusion vector of the first node from a single device in the S devices, aggregating the single mirror fusion vector to the local fusion vector of the first node, and updating the local fusion vector of the first node by using an aggregation result, until the S mirror fusion vectors sent by the S devices are all aggregated.

In an embodiment, the first device sets r mirror nodes for r neighboring nodes in the R neighboring nodes, and the fusing a current representation vector of the R neighboring nodes and a current representation vector of the first node includes: obtaining a current representation vector of r graph nodes corresponding to the r mirror nodes; and fusing a current representation vector of the R neighboring nodes, the current representation vector of the r graph nodes, and the current representation vector of the first node.

According to a second aspect, a data fusion apparatus for distributed graph learning is provided, and is applied to a distributed graph learning process for graph data in a distributed system. A single device in the distributed system is pre-allocated with a plurality of graph nodes of the graph data and a corresponding node connection relationship, a first device includes N graph nodes and M mirror nodes, a single mirror node is a mirror of a corresponding graph node on another device, the single graph node corresponding to the single mirror node on the another device and a single graph node in the N graph nodes are neighboring nodes of each other, the apparatus is disposed in the first device and includes a mirror fusion unit and a sending unit, and in a data fusion process for distributed graph learning: The mirror fusion unit is configured to perform the following fusion operations on each of the M mirror nodes through a plurality of mutually independent mirror fusion threads: obtaining a current representation vector of the single mirror node, where the current representation vector of the single mirror node is provided by a device in which the corresponding graph node is located; determining a mirror fusion vector of the single mirror node based on a current representation vector of the graph node and a current representation vector of each neighboring node of the graph node on the first device; and adding the mirror fusion vector to a local aggregation data sequence, where a representation vector of a single node is used to describe attribute information of a corresponding graph node.

The sending unit is configured to sequentially send, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.

According to a third aspect, a computer-readable storage medium is provided. The computer-readable storage medium stores a computer program, and when the computer program is executed on a computer, the computer is enabled to perform the method in the first aspect.

According to a fourth aspect, a computing device is provided, including a memory and a processor. The memory stores executable code, and when the processor executes the executable code, the method in the first aspect is implemented.

According to the method and the apparatus provided in the embodiments of this specification, in the distributed graph learning process, mirror nodes of neighboring nodes of local graph nodes are disposed on all devices, local information fusion is performed on a mirror node through a plurality of independent threads, fusion results are aggregated to the device in which the graph node is located, and the device in which the graph node is located further aggregates the fusion results. On a single device, an independent thread can perform local information fusion on all mirror nodes in parallel, and fusion results of all threads are provided to a corresponding device through the sending thread in a completion sequence, without a need to wait for each other, thereby improving distributed graph learning efficiency.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram illustrating a specific implementation architecture for distributed graph learning, according to this specification;

FIG. 2 is a flowchart illustrating a data fusion method for distributed graph learning, according to an embodiment;

FIG. 3 is a schematic diagram illustrating a mirror fusion procedure, according to an embodiment;

FIG. 4 is a schematic diagram illustrating a specific example of a data fusion procedure for distributed graph learning; and

FIG. 5 is a schematic block diagram illustrating a data fusion apparatus for distributed graph learning, according to an embodiment.

### DESCRIPTION OF EMBODIMENTS

The following describes the technical solutions provided in this specification with reference to the accompanying drawings.

A person skilled in the art can understand that, graph data can usually include a connection relationship between a node and a plurality of nodes. The graph data can be represented by several triplets such as a triplet form (a, r, b). Here, a and b represent two nodes, and r represents a connection relationship between the two nodes. The graph data can be visually represented in a form of a relationship network or a knowledge graph, and a connection relationship between nodes is represented by using a connection edge.

In practice, all nodes in the graph data respectively correspond to all entities associated with a specific service scenario. For example, when a specific service scenario is related to a user such as community discovery or user clustering, each service entity corresponding to each node in the graph data can be, for example, a user. For another example, in a specific scenario such as paper classification or social platform article classification, each service entity corresponding to each node in the graph data can be, for example, an article. In another specific service scenario, the service entity corresponding to the graph data can be any other proper entity. This is not limited here. One piece of graph data can correspond to one or more entities.

In the graph data, an entity corresponding to a single node can have various attributes related to a service. For example, in graph data that is used to push user consumption information, a service entity corresponding to the user can correspond to an attribute such as an age, an income, a residence location, or a consumption habit; and a service entity corresponding to the article can correspond to an attribute such as a keyword, a field to which the article belongs, or a length of the article. In an optional embodiment, two nodes that have an association relationship can further have an association attribute, and the association attribute can also be used as a side attribute of a corresponding connection edge. For example, users associated by using a social behavior can have a social attribute (for example, a chatting frequency, a transfer behavior, or a red packet giving behavior), and the social attribute is an association attribute between two corresponding nodes, and can be used as an edge attribute of a connection edge between the two corresponding nodes. Corresponding feature data can be extracted based on the attribute, to represent a corresponding node. Therefore, a node attribute and/or an edge attribute can be represented by a feature vector. The feature vector can be considered as an initial expression vector of a corresponding node or a connection edge. One piece of graph data includes at least a feature vector of each node, and can include a feature vector of the connection edge in an optional service scenario.

The graph data can be processed by using various graph models. The graph model can be, for example, a service model such as a graph neural network, RDF2Vec, or a Weisfeiler-Lehmankernels (Weisfeiler-Lehmankernels, WL) algorithm. The graph model can usually consider mutual impact of neighboring nodes. For a single node, feature nodes of neighboring nodes of the single node are fused, to obtain a final expression vector. In an embodiment, only a feature vector of the node is considered when vectors of the neighboring nodes are fused. For example, the vectors of the neighboring nodes of the single node can be fused by obtaining any one of a sum, an average, a weighted average, a median, a maximum value, etc. In another embodiment, in addition to considering the feature vector of the node when the vectors of the neighboring nodes are fused, the feature vector of the connection edge is considered. For example, a weight of an expression vector of the neighboring node is determined based on the vector of the connection edge, and the vector of the connection edge is used as a to-be-fused neighbor vector.

In a specific example of the graph neural network, all nodes can be traversed in a single-layer neural network. For a single node, a neighbor weight is set in a predetermined manner, to describe a degree of importance of a neighboring node to the single node. The predetermined manner here can be, for example, that the neighbor weight is negatively related to the node, is positively related to relevance between expression vectors of the single node and a corresponding neighboring node, etc. When the graph data includes the feature vector of the connection edge, the neighbor weight can be further determined based on the feature vector of the connection edge. Details are omitted here for simplicity. Further, a weighted sum of current expression vectors of the single node can be obtained based on a neighbor weight of each neighboring node, and the expression vector of the single node can be updated. For example, a data aggregation process of a node u at the kth layer is represented as g(u)^{k}=ΣW^{k}[(wv)^{k-1}+b]. Here, W^{k} is a parameter matrix (which is also a parameter that needs to be determined in a graph learning process) of the kth layer, v is a representation vector of a single neighboring node of the node u at the (k−1)^{th} layer, w is a weight of a single neighboring node in the aggregation process of the node u, and b is a constant parameter. After being processed by a single-layer graph neural network, an expression vector of each node is updated. For iteration of a multi-layer graph neural network, impact factors of a plurality of layers of neighbors can be fully considered, and a final expression vector is provided for the single node.

In a graph learning architecture, if used graph data includes a hyperscale graph node (that is, a node in the graph data, which is referred to as a graph node to be distinguished from the following mirror node), for example, a graph node at a level of one billion or 10 billion, the graph learning architecture can be deployed as a distributed graph learning architecture, and data of the graph node is distributed in all distributed graph learning devices in the graph learning architecture through graph partitioning. In a process of distributing graph nodes to each distributed graph learning device, a large quantity of adjacent points can exist. The adjacent point can be used to indicate a graph node that is allocated to one of the devices but has an association relationship with at least one another graph node that is allocated to another device. It can be understood that, for a critical point, in a process of fusing neighbor information, not only a local node but also a node of another device is used Therefore, how to more effectively fuse neighbor information of adjacent points is an important part of distributed graph learning.

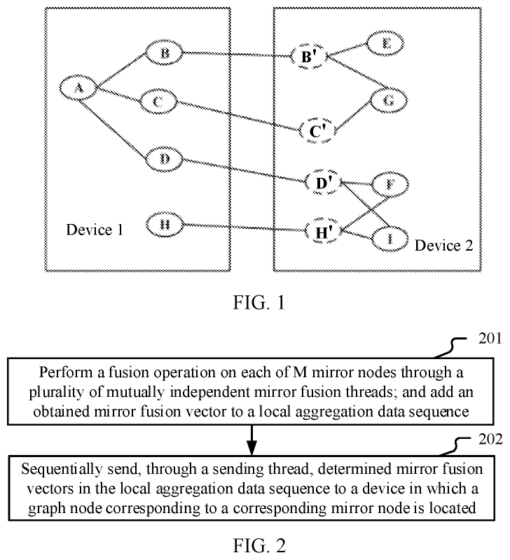

FIG. 1 shows an example of distributed deployment. As shown in FIG. 1, if nodes B, C, D, and H deployed on a device 1 have an association relationship with nodes deployed on a device 2, the nodes can be referred to as adjacent points. Further, for an adjacent node, a device in which the adjacent node is located can be referred to as a master device (or a master device) of the node, and the node in the master device can be referred to as a master node, and is directly referred to as a graph node below. In addition, in another graph learning device in which a remaining neighboring node of the adjacent node is located, a mirror node of the adjacent node can be created, or is referred to as a mirror node. As shown in FIG. 1, because nodes B, C, D, and H deployed on the device 1 are respectively neighboring nodes of nodes “E, G”, “F, I”, “F, I”, and “F, I” deployed on the device 2, corresponding mirror nodes B′, C′, D′, and H′ can be created on the device 2.

In a graph learning process, to maintain uniformity of data, data of each graph node can be stored by a master device corresponding to the graph node, and another device obtains data from the master device of the graph node based on a need. That is, the device in which the mirror node is located does not store a fusion result of a corresponding graph node. In a calculation process, if a graph node has a mirror node, a device in which the mirror node is located fuses local neighboring node data of a corresponding graph node in the device, and aggregates the fused local neighboring node data to a device in which the graph node is located, so that the device in which the graph node obtains a final aggregation result. The node B in FIG. 1 is used as an example. The device 1 is a master device of the node B. When neighbor information of the node B is aggregated, the device 2 can obtain a current representation vector of the node B from the device 1, and determine neighbor information (for example, denoted as a current fusion contribution vector) provided by neighboring nodes E and G of the node B to the node B. It should be noted that, FIG. 1 shows only one device 2 including a mirror node of B. Actually, there can be a plurality of such devices. The device is provided with a mirror node of a graph node B because the device includes a neighboring node of the graph node B. Each of the devices can send, to the device 1, neighbor information provided by the device to the node B. The device 1 can fuse the information, to complete aggregation of neighbor information of the graph node B.

With reference to FIG. 1, the foregoing describes a neighbor information fusion process for a single adjacent point in a distributed graph learning process. In practice, a plurality of adjacent points need to be further considered. When a large quantity of adjacent points in the graph data are simultaneously calculated, problems such as communication waiting and calculation waiting can occur, and consequently, graph learning efficiency is reduced.

Therefore, this specification provides a solution for implementing node concurrent processing through a parallel network thread. In a node information fusion process for distributed graph learning, on a single device, a device in which a corresponding graph node is located can be separately notified for a mirror node for which processing is completed, thereby reducing waiting time, and mutually independent threads can perform parallel execution, thereby reducing calculation time. In this way, data fusion efficiency of distributed graph learning can be improved in general.

The following describes the technical concept of this specification in detail with reference to a specific embodiment.

FIG. 2 shows a data fusion procedure for distributed graph learning, according to an embodiment of this specification. In this procedure, for ease of description, descriptions are provided from a perspective of a first device in a distributed system. The first device can be specifically any computer, system, server, etc. that has a specific computing capability, for example, the device 1 and the device 2 in FIG. 1. In the distributed system, a single device can be allocated with a certain quantity of graph nodes, to serve as a master device of the graph nodes in a graph learning process to aggregate and store data of the graph nodes. Graph data can be allocated through point cutting or edge cutting, and quantities of graph nodes on all devices can be equal or unequal. This is not limited here.

It is assumed that, a quantity of graph nodes allocated to the first device is N (N is an integer greater than 1). In the N graph nodes, a neighboring node of a single graph node can be all included in N graph nodes of the first device, or can be partially or all allocated to another device (for example, all neighboring nodes of a node H on the device 1 in FIG. 1 are allocated to the another device). For the latter, a mirror node of the some or all neighboring nodes can be disposed on the first device, and a mirror node of the single graph node can be disposed on the another device. In this specification, descriptions are provided from a perspective of the first device. For the first device, mirror nodes of the N graph nodes and mirror nodes of other neighboring nodes different from the N graph nodes can be disposed. As shown in FIG. 1, mirror nodes B′, C′, D′, and H′ of neighboring nodes B, C, D, and H of graph nodes E, G, F, and I are disposed on the device 2. It can be understood that, FIG. 1 is only an example. In practice, mirror nodes E′, G′, F′, and I′ of graph nodes B, C, D, and H can be disposed on the device 1, and the mirror nodes B′, C′, D′, and H′ do not need to be disposed on the device 2; or mirror nodes E′ and G′ of the graph nodes E and G are disposed on the device 1, and mirror nodes B′ and H′ are disposed on the device 2. This is not limited here. It can be assumed here that, a quantity of mirror nodes disposed on the first device is M. Here, M is a positive integer, a value of M is determined based on an actual service situation, and is not necessarily related to N.

It should be noted that, the first device can be any device in the distributed system. In other words, in the distributed system, such a device necessarily exists, a plurality of graph nodes (for example, N graph nodes) are allocated to the device, and at least one mirror node (for example, M mirror nodes) is included. Such a device can serve as the first device here. Optionally, the graph node on the first device can correspond to a mirror node on the another device. The neighboring node used in this specification can be a first-order neighboring node or a multi-order neighboring node. This is not limited here.

It can be understood by a person skilled in the art that, in a process of processing graph data by using a graph model, a representation vector of a neighboring node of a single graph node can be usually fused with an expression vector of the single graph node, to aggregate neighbor information to express the graph node. The aggregation process can be a process of one time, or can be a process of a plurality of times of iteration (the graph model is a multi-layer iterative structure). In this process, a node representation vector existing before the neighbor information is aggregated is used as a current representation vector of a corresponding graph node. The current representation vector of the graph node can be initially a feature vector extracted based on node attribute information. When a plurality of times of iteration need to be performed in a process of aggregating the neighbor information, a node representation vector obtained through a previous time of iteration is the current representation vector of the corresponding graph node. The node representation vector obtained through a previous time of iteration can also be considered as a representation vector corresponding to attribute information that is of the single graph node and that is fused at a previous layer. When the graph model is a multi-layer iterative structure, the procedure shown in FIG. 2 can correspond to a single layer of the graph model.

As shown in FIG. 2, the data fusion procedure for distributed graph learning provided in this specification can include: Step 201: Perform a fusion operation on each of M mirror nodes through a plurality of mutually independent mirror fusion threads; and add an obtained mirror fusion vector to a local aggregation data sequence. Step 202: Sequentially send, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of a first node.

In an aspect, in step 201, the fusion operation is performed on each of the M mirror nodes through the plurality of mutually independent mirror fusion threads, and the obtained mirror fusion vector is added to the local aggregation data sequence.

It can be understood that, a thread (thread) is a smallest unit in which an operating system can perform operation and scheduling, can be included in a process, and is an actual operating unit in the process. One thread can describe a control flow in a single sequence in the process. A plurality of threads can be concurrent in one process, and all threads perform different tasks in parallel.

In this embodiment of this specification, a plurality of threads for performing a fusion operation on the mirror node can be disposed on the first device, and these threads are independent of each other. The thread can be referred as a mirror fusion thread here. A quantity of mirror fusion threads can be consistent with a quantity of mirror nodes, or can be less than a quantity of mirror nodes. This is not limited here. For example, when the first device has 100 CPUs, a maximum of 100 mirror fusion threads can be simultaneously run, to perform a fusion operation of 180 mirror nodes. In practice, such a thread can also dynamically change based on a quantity of to-be-processed mirror nodes. To be specific, mirror node fusion threads whose quantity is the same as a quantity of mirror nodes that need to be processed in parallel are established, and a maximum of a quantity of mirror node fusion threads cannot exceed a quantity of CPUs of the device.

In step 201, in response to receiving data of one mirror node, one mirror fusion thread can be enabled, and the mirror fusion thread obtains a current representation vector of the mirror node. A fixed correspondence can possibly not be set between each mirror fusion thread and the mirror node. In an embodiment, when the first device receives a current representation vector of a local mirror node, the current representation vector and the mirror node can be correspondingly recorded in a candidate node sequence or a candidate node queue, for example, can be denoted as a mirror VertexQueue queue. The queue can sequentially provide data for each mirror fusion thread based on a data record sequence. Optionally, the first device can further record a corresponding mirror node as a “ready” (ready) state.

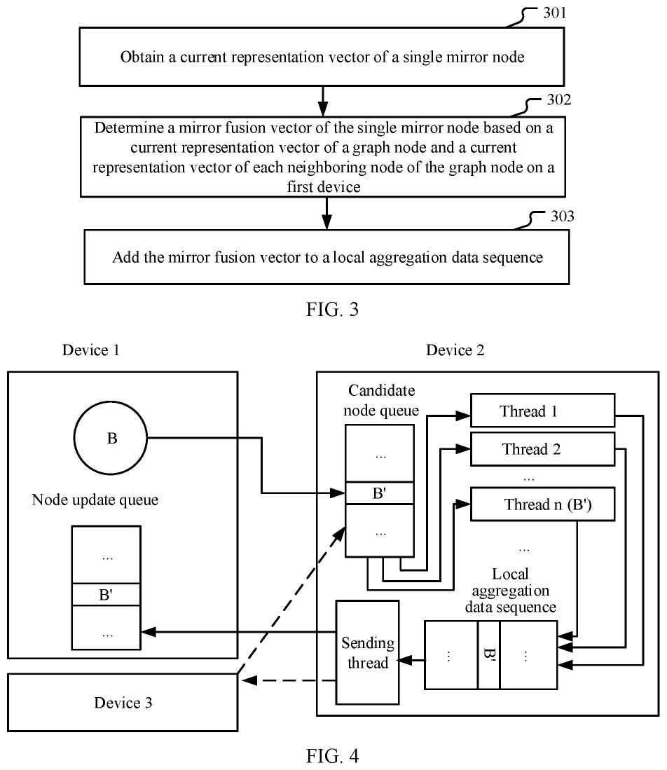

For a single mirror node, a fusion operation shown in FIG. 3 can be performed by executing a single mirror fusion thread. As shown in FIG. 3, the fusion operation can include the following steps.

Step 301: Obtain a current representation vector of a single mirror node. The current representation vector of the single mirror node can be obtained, based on a request of a current mirror fusion thread, from a device in which a graph node corresponding to the single mirror node is located, or can be obtained by a current mirror fusion thread from a candidate node sequence or a candidate node queue. This is not limited here.

It can be learned from the concept of the above-mentioned descriptions that in this specification, the current representation vector is finally obtained through aggregation by a device in which a corresponding graph node is located, and a mirror node does not store current representation vector data of the corresponding graph node. Therefore, when local calculation is performed, the current representation vector of the mirror node can be obtained from the device in which the corresponding graph node is located. The node B in FIG. 1 is used as an example. When neighbor vector information of the graph node B is fused, the device 2 can provide fusion information (represented by a mirror fusion vector) of a mirror node B′ and neighboring nodes E and G, and then the device 1 (a master device of the node B) aggregates fusion information of all mirror nodes, to update a current representation vector of the graph node B. The current representation vector of the graph node can be requested and obtained by the device in which the mirror node is located, or can be obtained by being actively delivered by the device in which the graph node is located to a device in which a mirror node of the graph node is located. This is not limited herein.

Step 302: Determine a mirror fusion vector of the single mirror node based on a current representation vector of the graph node and a current representation vector of each neighboring node of the graph node on the first device. Here, “graph node” is a graph node corresponding to the current mirror node. It can be understood that a current fusion vector of the single mirror node represents information contributed by a neighboring node related to the device in which the single mirror node is located to the information fusion of the corresponding graph node in a neighbor information fusion process of the corresponding graph node.

A mirror fusion vector of the current mirror node can be determined in any proper manner such as obtaining a sum, an average, a weighted sum, a median, etc. of the current representation vector and a current representation vector of a neighboring node of the graph node in the N graph nodes. This is not limited here. For the mirror node B′ in FIG. 1, a mirror fusion vector determined by the device 2 can be determined by obtaining any one of a sum, an average, a weighted summation, a median, etc. of current representation vectors of the graph node E and the graph node G. The weighted sum is used as an example. For example, a weight corresponding to a single graph node can be positively correlated with a similarity between a current representation vector of the single graph node and a current representation vector of a mirror node. For example, for the mirror node B′ in FIG. 1, a mirror fusion vector determined by the device 2 is g(B′)=Ww_{(B′˜E)}\tilde{E}+Ww_{(B′˜G)}\tilde{G}. Here, w_{(B)′˜E)} and W(B′ G) respectively represent weights determined based on similarities between the current representation vector of the graph node B and both of the current representation vector of the graph node E and the graph node G, W is a current parameter matrix, and \tilde{E} and \tilde{G} respectively represent current representation vectors of the graph node E and the graph node G.

Step 303: Add the mirror fusion vector to a local aggregation data sequence.

After a mirror fusion vector (for example, g(B′)) of a single mirror node (for example, B′ in FIG. 1) at a current device is determined, the mirror fusion vector can be provided to the device in which the corresponding graph node (for example, B) is located. To reduce time consumed for calculation waiting and communication wait, a message queue can be used in a concept of this specification. For example, a mirror fusion vector of each mirror node can be added to a local aggregation data sequence when a respective mirror fusion thread performs a fusion operation. The local aggregation data sequence is used to store a current fusion contribution vector of the local mirror node. For example, the current fusion contribution vector is stored in a mirror VertexGatherReadyQueue queue. Optionally, a state of a corresponding mirror node can be further set to a “Done” (Done) state.

Each thread can be independently executed in the procedure shown in FIG. 3, to determine local aggregation data of a single mirror node and add the local aggregation data to the local aggregation data sequence. A node state is recorded, to help ensure that an aggregation operation performed for each node in each loop can be fully performed, to avoid missing.

In addition, in step 202, the determined mirror fusion vector in the local aggregation data sequence is sequentially sent to the device in which the graph node corresponding to the corresponding mirror node is located through the sending thread. In this way, the device in which the corresponding graph node is located can determine, based on the corresponding mirror fusion vector, attribute information fused for the corresponding graph node, to update a current representation vector of the corresponding graph node.

The sending thread can be a communications thread configured to send data to another device. The sending thread sequentially obtains a single mirror fusion vector in a local aggregation data sequence (for example, a mirrorVertexGatherReadyQueue queue), and sends the single mirror fusion vector to the device in which the corresponding graph node is located. For example, after the mirror fusion vector of the mirror node B′ is obtained, the mirror fusion vector is sent to the device in which the mirror node B is located, that is, the device 1.

It should be noted that, to reduce waiting, step 201 and step 202 can be performed in parallel.

For the device in which the graph node is located, the device can determine, based on a received mirror fusion vector of the corresponding graph node, attribute information fused for the corresponding graph node. The fused attribute information can be represented by a vector, for example, is recorded as a fusion vector, and is used to update the current representation vector of the corresponding graph node. For example, each mirror fusion vector of a corresponding graph node and a current representation vector of a local neighboring node can be aggregated together, to obtain a fusion vector. To execute all graph nodes in parallel, the device in which the graph node is located can respectively aggregate all the graph nodes through a plurality of aggregation threads. In this case, the procedure shown in FIG. 2 can further include: fusing a current representation vector of a local neighboring node of each local graph node through each local fusion thread in the plurality of local fusion threads. The local neighboring node here can include a local mirror node.

When at least one graph node in the first device has a mirror node in another device, the first device can determine, through a local fusion thread, attribute information fused for a corresponding graph node.

It can be understood that, when a single device includes a graph node corresponding to a mirror node in another device and includes a mirror node corresponding to a graph node allocated to the another device, if a fusion operation performed on the mirror node is logically consistent with a fusion operation performed on the graph node, for example, both are an addition operation, the mirror fusion thread and the local fusion thread can be universal. In this way, it is more conducive to saving resources.

Any graph node (referred to as a first node below) in the N graph nodes on the first device is used as an example. It is assumed that a quantity of devices provided with a mirror node of the first node is S, and a quantity of local neighboring nodes is R (R≥0, and R=0 indicates that there is no local neighboring node). Therefore, the first device can receive a total of S mirror fusion vectors. The first device can fuse the S mirror fusion vectors with a current representation vector of the first node and a current representation vector of the R neighboring nodes through the local fusion thread, to obtain attribute information fused for the first node and use the attribute information as a fusion result. Further, the current representation vector of the first node can be updated based on the fusion result.

In a possible design, the procedure in FIG. 2 further includes: fusing a current representation vector of the R neighboring nodes and a current representation vector of the first node through a single local fusion thread in a plurality of local fusion threads, to obtain a local fusion vector of the first node; and fusing, through a single aggregation thread in a plurality of aggregation threads, the local fusion vector and S mirror fusion vectors respectively determined by the S devices for the first node, to obtain attribute information fused for the first node, so as to update the current representation vector of the first node.

The fusion process is equivalent to gathering and aggregation of fusion results of the local neighboring node of the first node on each device. Here, a thread that performs the aggregation and fusion operation can be referred to as an aggregation thread. The first device can include a plurality of aggregation threads. For each local graph node, a local fusion vector and S mirror fusion vectors are independently fused. In a process of fusing the local fusion vector and the S mirror fusion vectors, a corresponding fusion manner can be set based on a service requirement.

In an embodiment, after receiving the S mirror fusion vectors for the first node, the local fusion vector and the S mirror fusion vectors can be fused at one time. In this case, after the S mirror fusion vectors of the first node are separately obtained from the S devices, a single aggregation thread performs an aggregation operation on the first node. The aggregation operation can be, for example, obtaining the S mirror fusion vectors, and fusing the S current fusion contribution vectors with the current representation vector of the first node. The node B is used as an example, and a corresponding fusion manner is, for example, obtaining one of a sum, an average, a weighted average, a medium, a maximum value, etc. of the S current fusion contribution vectors and the current representation vector of the first node. For example, an addition manner is as follows: h(B^{k-1})=g₁(B^{k})+ . . . +gₛ(B^{k})+h(B^{k}). Here, k represents the current representation vector, k+1 represents a fusion result of an aggregation thread, g represents a mirror fusion vector, and a subscript of g represents a sequence number of a mirror node provided with the node B. In this implementation, a quantity of thread invocation times can be reduced, and importance of each fusion contribution vector can be comprehensively considered during aggregation.

In another embodiment, the S mirror fusion vectors can be fused in a receiving sequence to obtain a mirror aggregation result, and then the mirror aggregation result is fused with the local fusion vector of the first node. In this case, the mirror fusion vector is, for example, a zero vector. In response to receiving the single mirror fusion vector of the first node from a single device in the S devices, the mirror fusion vector can be aggregated to the mirror fusion vector of the first node through a single aggregation thread in the plurality of aggregation threads, until the S mirror fusion vectors sent by the S devices are all aggregated to obtain a mirror aggregation result, and the mirror aggregation result is fused with the local fusion vector of the first node, to update the current representation vector of the first node based on the fusion result. In short, in an aggregation manner provided in this embodiment, each time a mirror fusion vector is received, an aggregation thread is invoked to fuse the mirror fusion vector with a current mirror aggregation result, until all fusion contribution vectors of the single graph node are fused, to obtain a final mirror aggregation result for the node, and aggregate the final mirror aggregation result with the local fusion vector of the first node. In the aggregation manner, an asynchronous manner is used in an aggregation process, and processing can be performed in a data feedback sequence, to reduce waiting.

In still another embodiment, after the local fusion vector of the first node is obtained, in response to receiving the mirror fusion vector of the first node from the single device in the S devices, the aggregation thread is invoked for one time to aggregate the mirror fusion vector to the local fusion vector of the first node, and the local fusion vector of the first node is updated. A current round of information fusion of the first node is not completed until S current fusion contribution vectors sent by the S devices are aggregated. In the aggregation manner, information can be asynchronously fused based on a data feedback sequence, to reduce waiting, and a result is directly obtained, to reduce steps.

In more embodiments, an aggregation manner of the mirror fusion vector and the local fusion vector of the graph node can be further set in another manner. Details are omitted here for simplicity. In an embodiment, after all vectors of the single graph node are fused, a state of the graph node can be further set to a “Done” (Done) state, and the graph node is added to a node update queue, for example, a master VertexGatherDoneQueue queue, to indicate that a representation vector of a node in a current round is updated. The state is marked, to help fully perform a fusion operation of each stage for all nodes. Optionally, after a next round of iteration (for example, a next layer of the graph model) starts, data in the node update queue can be sequentially extracted, and is distributed to all mirror node devices through the sending thread.

In a possible design, the local fusion thread and the mirror fusion thread have the same logic, and can be universal. In this case, when the mirror fusion operation is locally performed (for the mirror node), a local node fusion operation can also be performed (for the local graph node, for example, the above-mentioned master node).

In a review of the above-mentioned process, in the method provided in this embodiment of this specification, a plurality of threads can be performed in parallel in a data fusion process of a mirror node or a graph node, to implement multi-point concurrency. In addition, a local aggregation data sequence shared by the plurality of threads is used as a message transfer means, and a current fusion contribution vector obtained by performing information aggregation on a single mirror node locally is ranked, and is separately sent by the sending thread, so that a device in which a corresponding graph node is located implements asynchronous data fusion of nodes, to reduce waiting. Therefore, the method described in the above-mentioned embodiment can improve data aggregation efficiency in the distributed graph learning process.

To better express the technical effect achieved by the technical concept of this specification, references can be made to FIG. 4. To reflect the technical concept of this specification, in FIG. 4, that a device 2 executes a data fusion procedure of distributed graph learning provided in this specification is used as an example. With reference to interaction with a device 1, the descriptions mainly relates to an idea. Certainly, the device 2 can further similarly interact with a device such as the device 3, and is briefly represented by a dashed arrow here.

As shown in FIG. 4, it is assumed that a graph node B is a graph node allocated to the device 1, and the device 2 can correspond to a mirror node B′ of the graph node B. In a neighbor information fusion process (for example, a certain time of iteration of a graph model), the device 2 can obtain a current representation vector of the node B from the device 1 and add the current representation vector to a candidate node queue. In a process of executing a plurality of mirror fusion threads, current representation vectors of candidate nodes are sequentially extracted from candidate node queues, and neighboring node information is fused. As shown in FIG. 3, assuming that a mirror fusion thread n obtains the current representation vector of the node B, the thread n can perform a fusion operation, determine a mirror fusion vector of the mirror node B′ on the device 2, and store the mirror fusion vector in a local aggregation data sequence. In this way, parallel fusion of a plurality of mirror nodes can be implemented through the plurality of mirror fusion threads.

In addition, the device 2 is further provided with a sending thread, and the sending thread can sequentially obtain each mirror fusion vector from the local aggregation data sequence, and send the mirror fusion vector to a device in which a corresponding graph node is located. For example, in FIG. 4, after the mirror fusion vector of the mirror node B′ is obtained, the mirror fusion vector is sent to the device 1 in which the graph node B is located. As shown in FIG. 4, the sending thread can further provide a mirror fusion vector of another mirror node to another device (for example, a device 3). Details are omitted here for simplicity. By using the sending thread, mirror fusion vectors of all mirror nodes are sent one by one, without a need to wait for each other, thereby reducing waiting duration.

In addition, the sending thread and the plurality of mirror fusion threads can be further executed in parallel. It can be learned from FIG. 4 that, in this manner, data processing duration of communication waiting and data fusion can be reduced by combining a queue with a parallel thread, thereby improving data fusion efficiency of distributed graph learning.

An embodiment of another aspect further provides a data fusion apparatus for distributed graph learning. Each device in a distributed system for graph learning can be provided with a data fusion apparatus for distributed graph learning. A single device in the distributed system is pre-allocated with a plurality of graph nodes of the graph data and a corresponding node connection relationship. For ease of description, an example in which the apparatus is disposed in any device in the distributed system is used for description. The any device is referred to as a first device. It is assumed that the first device includes N graph nodes and M mirror nodes, and a single mirror node and a single graph node in the N graph nodes are neighboring nodes.

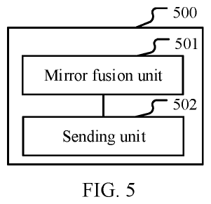

As shown in FIG. 5, a data fusion apparatus 500 for distributed graph learning includes a mirror fusion unit 501 and a sending unit 502. In a data fusion process for distributed graph learning, the mirror fusion unit 501 is configured to perform the following fusion operations on each of the M mirror nodes through a plurality of mutually independent mirror fusion threads: obtaining a current representation vector of the single mirror node, where the current representation vector of the single mirror node is provided by a device in which the corresponding graph node is located; determining a mirror fusion vector of the single mirror node based on a current representation vector of the graph node and a current representation vector of each neighboring node of the graph node on the first device; and adding the mirror fusion vector to a local aggregation data sequence, where a representation vector of a single node is used to describe attribute information of a corresponding graph node; and the sending unit 502 is configured to sequentially send, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.

In an embodiment, the graph learning is performed by processing the graph data by using a graph model with a multi-layer iterative structure, the fusion operation is correspondingly performed at a single layer of the graph model, and when the single layer is the first layer, a current representation vector of the single graph node is a feature vector extracted based on attribute information of an entity corresponding to the single graph node, or when the single layer is not the first layer, a current representation vector of the single graph node is a representation vector corresponding to attribute information that is of the single graph node and that is fused at a previous layer.

In an optional implementation, the apparatus 500 can further include a receiving unit (not shown), configured to: record the graph node in a candidate node queue when the device in which the graph node corresponding to the single mirror node is located provides the current representation vector of the graph node, where the candidate node queue is used to store a current representation vector of a local mirror node or a local graph node, and all the fusion threads sequentially obtain a single current representation vector at a single time.

In some implementations, the mirror fusion vector of the single mirror node is determined by obtaining one of a sum, an average, a weighted sum, and a median of current representation vectors of neighboring nodes of the graph node in the N graph nodes.

In a possible design, it is assumed that the N graph nodes include a first node, the first node corresponds to T neighboring nodes and R local neighboring nodes distributed on S devices, T is greater than or equal to S, R is greater than or equal to 0, and the apparatus 500 further includes a local fusion unit and an aggregation unit (not shown). The local fusion unit is configured to fuse a current representation vector of the R neighboring nodes and a current representation vector of the first node through a single local fusion thread in a plurality of local fusion threads, to obtain a local fusion vector of the first node; and the aggregation unit is configured to fuse, through a single aggregation thread in a plurality of aggregation threads, the local fusion vector and S mirror fusion vectors respectively determined by the S devices for the first node, to obtain attribute information fused for the first node, so as to update the current representation vector of the first node.

In an embodiment, the aggregation unit is further configured to: obtain the S mirror fusion vectors respectively determined by the S devices for the first node; and fuse the S mirror fusion vectors and the local fusion vector of the first node.

In another embodiment, the aggregation unit is further configured to: obtain a single mirror fusion vector that is of the first node and that is received from a single device in the S devices; aggregate the single mirror fusion vector to a mirror aggregation vector of the first node until the S mirror fusion vectors sent by the S devices are all aggregated, to obtain a mirror aggregation result; and fuse the mirror aggregation result and the local fusion vector of the first node.

In still another embodiment, the aggregation unit is further configured to: in response to receiving a single mirror fusion vector of the first node from a single device in the S devices, aggregate the current fusion contribution vector to the local fusion vector of the first node, and update the local fusion vector of the first node by using an aggregation result, until the S mirror fusion vectors sent by the S devices are all aggregated.

It should be noted that the apparatus 500 shown in FIG. 5 corresponds to the method described in FIG. 2, and corresponding descriptions in the method embodiment in FIG. 2 are also applicable to the apparatus 500. Details are omitted here for simplicity.

An embodiment of another aspect further provides a computer-readable storage medium. The computer-readable storage medium stores a computer program, and when the computer program is executed on a computer, the computer is enabled to perform the method described with reference to FIG. 2, etc.

An embodiment of still another aspect further provides a computing device, including a memory and a processor. The memory stores executable code, and when the processor executes the executable code, the method described with reference to FIG. 2, etc. is implemented.

A person skilled in the art should be aware that in the one or more examples, functions described in embodiments of this specification can be implemented by hardware, software, firmware, or any combination thereof. When the functions are implemented by using software, the functions may be stored in a computer-readable medium or transmitted as one or more instructions or code in the computer-readable medium.

The objectives, technical solutions, and beneficial effect of the technical concepts of this specification are further described in detail in the above-mentioned specific implementations. It should be understood that the above-mentioned descriptions are merely specific implementations of the technical concepts of this specification, but are not intended to limit the protection scope of the technical concepts of this specification. Any modification, equivalent replacement, or improvement made based on the technical solutions of the technical concepts of this specification shall fall within the protection scope of the technical concepts of this specification.

1. A data fusion method for distributed graph learning, applied to a distributed graph learning process for graph data in a distributed system, wherein a single device in the distributed system is pre-allocated with a plurality of graph nodes of the graph data and a corresponding node connection relationship, a first device comprises N graph nodes and M mirror nodes, a single mirror node is a mirror of a corresponding graph node on another device, the single graph node corresponding to the single mirror node on the another device and a single graph node in the N graph nodes are neighboring nodes of each other, and in a data fusion process for distributed graph learning, the method is performed by the first device, and comprises:
performing the following fusion operations on each of the M mirror nodes through a plurality of mutually independent mirror fusion threads: obtaining a current representation vector of the single mirror node, wherein the current representation vector of the single mirror node is provided by a device in which the corresponding graph node is located; determining a mirror fusion vector of the single mirror node based on a current representation vector of the graph node and a current representation vector of each neighboring node of the graph node on the first device, wherein a representation vector of a single node is used to describe attribute information of a corresponding graph node; and adding the mirror fusion vector to a local aggregation data sequence; and
sequentially sending, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.

2. The method according to claim 1, wherein the graph learning is performed by processing the graph data by using a graph model with a multi-layer iterative structure, the fusion operation is correspondingly performed at a single layer of the graph model, and upon determining that the single layer is the first layer, a current representation vector of the single graph node is a feature vector extracted based on attribute information of an entity corresponding to the single graph node, or upon determining that the single layer is not the first layer, a current representation vector of the single graph node is a representation vector corresponding to attribute information that is of the single graph node and that is fused at a previous layer.

3. The method according to claim 1, wherein the graph node is recorded in a candidate node queue upon determining that the device in which the graph node corresponding to the single mirror node is located provides the current representation vector of the graph node, the candidate node queue is used to store a current representation vector of a local mirror node or a local graph node, and all the fusion threads sequentially obtain a single current representation vector at a single time.

4. The method according to claim 1, wherein the mirror fusion vector of the single mirror node is determined by obtaining one of a sum, an average, a weighted sum, and a median of current representation vectors of neighboring nodes of the graph node in the N graph nodes.

5. The method according to claim 1, wherein the N graph nodes comprise a first node, the first node corresponds to mirror nodes distributed on S devices and R local neighboring nodes, R is greater than or equal to 0, and for the first node, the method further comprises:
fusing a current representation vector of the R neighboring nodes and a current representation vector of the first node through a single local fusion thread in a plurality of local fusion threads, to obtain a local fusion vector of the first node; and
fusing, through a single aggregation thread in a plurality of aggregation threads, the local fusion vector and S mirror fusion vectors respectively determined by the S devices for the first node, to obtain attribute information fused for the first node, so as to update the current representation vector of the first node.

6. The method according to claim 5, wherein the fusing, through a single aggregation thread in a plurality of aggregation threads, the local fusion vector and S mirror fusion vectors respectively determined by the S devices for the first node comprises: obtaining the S mirror fusion vectors respectively determined by the S devices for the first node; and
fusing the S mirror fusion vectors and the local fusion vector of the first node.

7. The method according to claim 5, wherein the fusing, through a single aggregation thread in a plurality of aggregation threads, the local fusion vector and S mirror fusion vectors respectively determined by the S devices for the first node comprises:
obtaining a single mirror fusion vector that is of the first node and that is received from a single device in the S devices;
aggregating the single mirror fusion vector to a mirror aggregation vector of the first node until the S mirror fusion vectors sent by the S devices are all aggregated, to obtain a mirror aggregation result; and
fusing the mirror aggregation result and the local fusion vector of the first node.

8. The method according to claim 5, wherein the fusing, through a single aggregation thread in a plurality of aggregation threads, the local fusion vector and S mirror fusion vectors respectively determined by the S devices for the first node comprises:
in response to receiving a single mirror fusion vector of the first node from a single device in the S devices, aggregating the single mirror fusion vector to the local fusion vector of the first node, and updating the local fusion vector of the first node by using an aggregation result, until the S mirror fusion vectors sent by the S devices are all aggregated.

9. The method according to claim 5, wherein the first device sets r mirror nodes for r neighboring nodes in the R neighboring nodes, and the fusing a current representation vector of the R neighboring nodes and a current representation vector of the first node comprises:
obtaining a current representation vector of r graph nodes corresponding to the r mirror nodes; and
fusing a current representation vector of the R neighboring nodes, the current representation vector of the r graph nodes, and the current representation vector of the first node.

10. (canceled)

11. (canceled)

12. (canceled)

13. (canceled)

14. (canceled)

15. (canceled)

16. (canceled)

17. (canceled)

18. A non-transitory computer-readable storage medium for distributed graph learning, applied to a distributed graph learning process for graph data in a distributed system, wherein a single device in the distributed system is pre-allocated with a plurality of graph nodes of the graph data and a corresponding node connection relationship, a first device comprises N graph nodes and M mirror nodes, a single mirror node is a mirror of a corresponding graph node on another device, the single graph node corresponding to the single mirror node on the another device and a single graph node in the N graph nodes are neighboring nodes of each other,
the non-transitory computer-readable storage medium comprising instructions stored therein that, when executed by a processor of a computing device, cause the processor to:
perform the following fusion operations on each of the M mirror nodes through a plurality of mutually independent mirror fusion threads: obtaining a current representation vector of the single mirror node, wherein the current representation vector of the single mirror node is provided by a device in which the corresponding graph node is located; determining a mirror fusion vector of the single mirror node based on a current representation vector of the graph node and a current representation vector of each neighboring node of the graph node on the first device, wherein a representation vector of a single node is used to describe attribute information of a corresponding graph node; and adding the mirror fusion vector to a local aggregation data sequence; and
sequentially send, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.

19. A computing device for distributed graph learning, applied to a distributed graph learning process for graph data in a distributed system, wherein a single device in the distributed system is pre-allocated with a plurality of graph nodes of the graph data and a corresponding node connection relationship, a first device comprises N graph nodes and M mirror nodes, a single mirror node is a mirror of a corresponding graph node on another device, the single graph node corresponding to the single mirror node on the another device and a single graph node in the N graph nodes are neighboring nodes of each other,
the computing device comprises:
a means for mirror fusion unit, configured to perform the following fusion operations on each of the M mirror nodes through a plurality of mutually independent mirror fusion threads: obtaining a current representation vector of the single mirror node, wherein the current representation vector of the single mirror node is provided by a device in which the corresponding graph node is located; determining a mirror fusion vector of the single mirror node based on a current representation vector of the graph node and a current representation vector of each neighboring node of the graph node on the first device; and adding the mirror fusion vector to a local aggregation data sequence, wherein a representation vector of a single node is used to describe attribute information of a corresponding graph node; and
a means for sending unit, configured to sequentially send, through a sending thread, determined mirror fusion vectors in the local aggregation data sequence to a device in which a graph node corresponding to a corresponding mirror node is located, so that the device in which the corresponding graph node is located determines, based on the corresponding mirror fusion vector, attribute information fused for the corresponding graph node, to update a current representation vector of the corresponding graph node.
